(19) United States
(12) Patent Application Publication
(10) Pub. No.: US 2026/0138363 A1
(43) Pub. Date: May 21, 2026

(54) PRINTING APPARATUS, CONTROL METHOD, AND STORAGE MEDIUM

(71) Applicant: CANON KABUSHIKI KAISHA, Tokyo (JP)

(72) Inventors: AKIRA FUJIKAKE, Kanagawa (JP); NAOAKI WADA, Kanagawa (JP); YUTO NITAMI, Kanagawa (JP)

(21) Appl. No.: 19/317,644

(22) Filed: Sep. 3, 2025

(30) Foreign Application Priority Data
Sep. 20, 2024 (JP) 2024-164344

(51) Int. Cl. B41J 2/045

(52) U.S. Cl. CPC B41J 2/04528; B41J 2/04563; B41J 2/0458

(57) ABSTRACT

The present disclosure is to provide a printing apparatus capable of efficient preheating. The printing apparatus includes a print head, a carriage, a heating section which selectively performs an ejection operation of ejecting liquid and a heating operation of warming liquid, and a control section. In a case where a distance between a reversing position at which the scan direction of the carriage is switched and a position at which the print head starts ejection in a next scan is longer than a predetermined distance, the control section causes the heating section to execute the heating operation while the carriage is accelerating in the next scan.

### BACKGROUND

### Field of the Technology

The present disclosure relates to a printing apparatus, a control method, and a storage medium.

### Description of the Related Art

A printing apparatus which ejects liquid and performs printing sometimes heats liquid to adjust the temperature of liquid before starting printing.

Japanese Patent Laid-Open No. H11-342604 (1999) discloses a printing apparatus which preheats liquid while a carriage is accelerating. According to the printing apparatus of Japanese Patent Laid-Open No. H11-342604 (1999), since a temperature change of liquid resulting from an actual print operation can be reduced, a density change associated with the temperature change is reduced and a decrease in density unevenness in a printed image is realized.

Incidentally, in order to perform preheating, there is a need to secure a distance sufficient to accelerate the carriage. In a case where a distance sufficient to accelerate the carriage cannot be secured for any reason, it is difficult to perform preheating while the carriage is accelerating. In this case, it is considered that preheating is performed with the carriage stopped after a preceding scan is finished, and a subsequent scan is performed after the temperature of liquid reaches a desirable temperature. However, this method requires the carriage to stop temporarily each time a scan is finished, which may result in a decrease in throughput.

### SUMMARY

The present disclosure is to provide a printing apparatus capable of efficient preheating.

A printing apparatus has: a print head configured to print an image on a print medium by ejecting liquid; a carriage mounted with the print head and configured to perform a reciprocal scan in a scan direction; a heating section configured to selectively perform an ejection operation of ejecting liquid from the print head by heating a heating element provided on the print head and a heating operation of heating the heating element to warm liquid included in the print head; and a control section configured to control movement of the carriage and the heating section, wherein in a case where a distance between a reversing position at which the scan direction of the carriage is switched and a position at which the print head starts ejection in a next scan is longer than a predetermined distance, the control section causes the heating section to execute the heating operation while the carriage is accelerating in the next scan.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view showing an example of a printing apparatus applicable to an embodiment.

FIG. 2 is a schematic cross-sectional view of the printing apparatus applicable to an embodiment.

FIG. 3 is a schematic bottom view of a carriage applicable to an embodiment.

FIG. 4 is a block diagram of the printing apparatus applicable to an embodiment.

FIG. 5 is a schematic perspective view of an element substrate applicable to an embodiment.

FIG. 6A is a diagram showing an ejection pulse applicable to an embodiment.

FIG. 6B is a diagram showing a temperature adjustment pulse applicable to an embodiment.

FIG. 7 is a diagram illustrating pulse parameters.

FIG. 8A is a diagram showing an example of a reversing position of the carriage applicable to an embodiment.

FIG. 8B is a diagram showing an example of the reversing position of the carriage applicable to an embodiment.

FIG. 9 is a flowchart showing an example of preheating applicable to an embodiment.

FIG. 10 is a diagram showing an example of a preheating timing applicable to an embodiment.

FIG. 11 is a diagram showing an example of the preheating timing applicable to an embodiment.

FIG. 12 is a diagram showing an example of accelerations of a carriage applicable to an embodiment.

### DESCRIPTION OF THE EMBODIMENTS

Embodiments are hereinafter described in detail with reference to the accompanying drawings. It should be noted that the following embodiments do not limit the claimed invention. Although a plurality of features are described in the embodiments, not all of these features are necessarily essential to the invention and the features may be arbitrarily combined. Further, in the accompanying drawings, identical or similar features are denoted by the same reference numeral and overlapping descriptions are omitted.

### First Embodiment

### <Printing Apparatus 1>

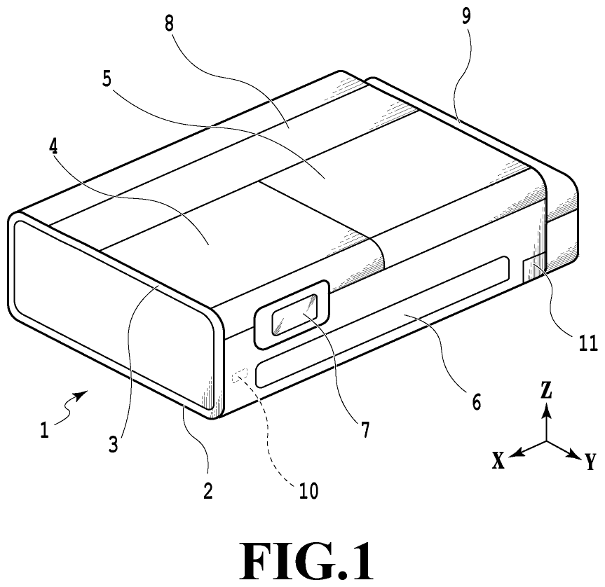

FIG. 1 is a schematic exterior view showing a printing apparatus 1 applicable to the present embodiment from the front.

As shown in FIG. 1, the printing apparatus 1 of the present embodiment is an inkjet printing apparatus which ejects ink as liquid and performs printing on a print medium. However, the technique of the present disclosure is also applicable to various apparatuses other than the inkjet printing apparatus.

In the drawings, arrows X and Y show horizontal directions orthogonal to each other on a plane. Arrow Z shows a vertical direction. In a posture of use of the printing apparatus 1, an upward direction (direction indicated by arrow Z) is an anti-gravity direction and a downward direction is a gravity direction. The X direction is a width direction (lateral direction) of the printing apparatus 1. The Y direction is a depth direction of the printing apparatus 1.

It should be noted that “printing” is not limited to formation of meaningful information such as characters and figures but also widely includes formation of an image, design, pattern, and the like on a print medium or processing of a medium regardless of whether it is meaningful or meaningless. In “printing,” it does not matter whether elicitation is performed for human visibility. In the present embodiment, it is assumed that “print medium” is a sheet of paper. However, “print medium” may be a cloth, plastic, film, or the like.

The printing apparatus 1 has the shape of a flat rectangular cuboid as a whole. The printing apparatus 1 comprises an apparatus main body 2 and a main body covering section 3 including a plurality of covers. The main body covering section 3 is provided to cover the apparatus main body 2. The main body covering section 3 forms the top of the printing apparatus 1. The main body covering section 3 has a feeding cover 8 to set a print medium, an access cover 5 for maintenance work of the inside of the apparatus, and a tank cover 9 covering a portion to supply ink to a tank of the apparatus.

The printing apparatus 1 is provided with a scanner unit 4 which reads an image of a document. Like the access cover 5, the entire scanner unit 4 can also be opened and closed to perform maintenance work of the inside of the apparatus.

The front side of the printing apparatus 1 is provided with a discharge section 6 to discharge a printed print medium and an operation unit 7 to accept an operator's operation. The operation unit 7 includes a display section in the form of a touch panel to accept an operator's input operation and display various kinds of information. The front side of the printing apparatus 1 also comprises a notification section 10. The notification section 10 can make a notification sound for an operation of each unit. The front side of the printing apparatus 1 also comprises a waste liquid tank section 11 to insert a waste liquid tank.

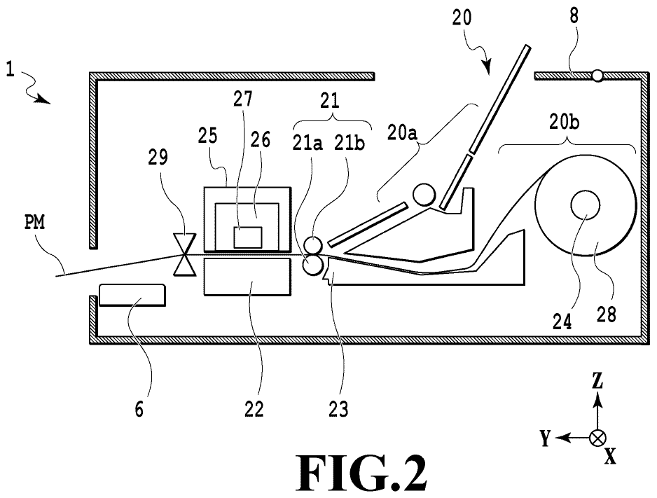

FIG. 2 is a schematic cross-sectional view showing an internal mechanism of the printing apparatus 1.

As shown in FIG. 2, the printing apparatus 1 includes a conveying section 21, a conveyance sensor 23, a feeding section 20, a printing unit 26, a detecting unit 27, and a cutter unit 29. The printing apparatus 1 is an apparatus configured to print an image on a print medium PM.

The print medium PM is accommodated in the feeding section 20. As a target selected as the print medium PM (hereinafter referred to as a printing target), the feeding section 20 is configured to accommodate each of a cut sheet of a size pursuant to a predetermined standard and a roll sheet 28 which is an elongate sheet wound into a roll. Examples of the above predetermined standard include Japanese Industrial Standards (JIS).

The feeding section 20 includes a stacking section 20a configured to be stacked with a plurality of cut sheets and a mounting section 20b rotatably mounted with the roll sheet 28 at a position different from the stacking section 20a. The stacking section 20a is provided downstream of the mounting section 20b in a conveyance direction (Y direction) of the print medium PM. A print operation for the roll sheet 28 fed from the mounting section 20b is described below.

The mounting section 20b comprises a holding section configured to hold the roll sheet 28, which is a continuous sheet wound into a roll, and an unshown driving section configured to drive the sheet held in the holding section to rotate. The mounting section 20b rotates the roll sheet 28 held in the holding section to feed the roll sheet 28 in a feeding direction of the roll sheet 28 (direction indicated by arrow Y) and a rewinding direction of the roll sheet 28 (opposite direction of the feeding direction). A spur member 24 is inserted into a paper tube of the roll sheet 28 and rotatably supported at the holding section of the feeding section 20. The feeding section 20 rotates the spur member 24 with a motor (not shown) to rotate the roll sheet 28.

The conveying section 21 includes a conveying roller to convey the print medium PM. In the present embodiment, a pair of a drive roller 21a and a follower roller 21b is used as the conveying roller. The conveying section 21 comprises an unshown drive mechanism and drives the drive roller to rotate. The follower roller 21b is in pressure contact with the drive roller 21a to follow the rotation. The print medium PM is sandwiched between the drive roller 21a and the follower roller 21b and conveyed on a platen 22.

As the drive mechanism of the conveying section 21, for example, a gear mechanism using a motor as a driving source is applicable. A rotation amount of the conveying section 21 is detected by an unshown sensor (e.g., encoder) and a conveyance amount of the print medium PM is controlled. In the following description, “upstream” or “downstream” means upstream or downstream in a conveying path of the print medium PM.

The roll sheet 28 and the conveying section 21 are provided such that their axial direction is parallel to a scan direction (±X direction) in which a carriage 25 performs a reciprocal scan from side to side. The conveyance sensor 23 is arranged upstream of the conveying section 21 in the conveyance direction. An example of the conveyance sensor 23 is an optical sensor to determine whether the roll sheet 28 is appropriately conveyed to the conveying section 21. The printing unit 26 is provided downstream of the conveying section 21. The printing unit 26 can print an image on the print medium PM conveyed by the conveying section 21.

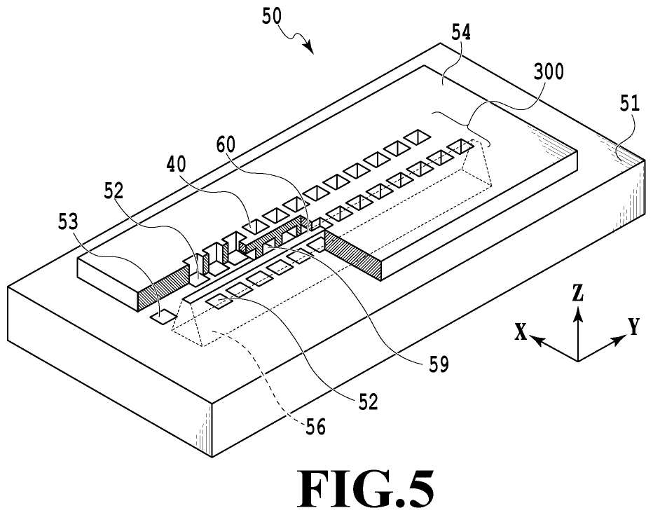

The printing unit 26 of the present embodiment includes a print head 102 (see FIG. 5) with a plurality of nozzles 40 (see FIG. 5 etc.) to eject ink and a temperature sensor 53 (see FIG. 5) to detect a temperature of the print head 102. The printing unit 26 is detachably attached to the carriage 25. The carriage 25 is connected to a tube to supply ink to the printing unit 26.

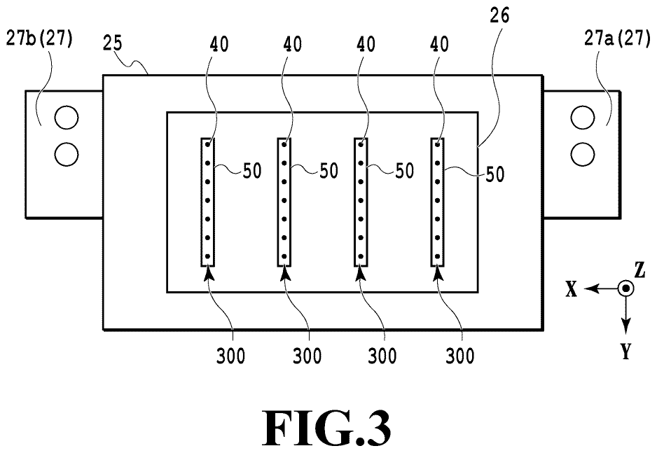

The carriage 25 can be reciprocally moved in the scan direction (X direction) by an unshown drive mechanism. An example of the drive mechanism of the carriage 25 is a belt drive mechanism using a motor as a driving source. The position of the carriage 25 is detected by the detecting unit 27 (see FIG. 3) or an unshown sensor (e.g., encoder). Depending on these detection results, the movement of the carriage 25 is controlled.

The detecting unit 27 can detect an image printed on the print medium PM, an edge of the print medium PM, a thickness of the print medium PM, and the like. The detecting unit 27 is mounted on the carriage 25. The detecting unit 27 moves in the scan direction together with the carriage 25. The detection result of the detecting unit 27 is associated with a position of the print medium PM based on the detection result of the position of the carriage 25 and the conveyance amount of the print medium PM by the conveying section 21. For example, the detecting unit 27 can also detect the position of the carriage 25.

The detecting unit 27 comprises, for example, an optical sensor including a light emitting element and a light receiving element. The light emitting element emits light toward the platen 22 or the print medium PM (see FIG. 2 etc.). On the other hand, the light receiving element receives the reflected light. In a case where a position of a front end of the print medium PM is detected by the detecting unit 27, for example, while the carriage 25 is stopped at the conveying path of the print medium PM, the print medium PM is conveyed in the feeding direction to pass through the detecting unit 27 once and is then fed backward in the rewinding direction.

Due to a difference in reflectivity between the platen 22 and the print medium PM, a value of light received by the light receiving element is changed by the passing of the front end of the print medium PM. In this case, from the detection result of the rotation amount of the conveying section 21, the position of the front end of the print medium PM can be detected. In the same manner, a position of an image printed on the print medium PM can also be detected based on the detection result of the rotation amount of the conveying section 21 at the point of change of the light receiving result of the light receiving element and the position detection result of the carriage 25.

The cutter unit 29 cuts the print medium PM in the scan direction. The cutter unit 29 can be reciprocally moved in the scan direction by an unshown cutter motor. The cutter unit 29 comprises a cutter. The cutter unit 29 may also have a pressure sensor to detect a pressure applied on the cutter.

FIG. 3 is a schematic bottom view of the carriage 25 applicable to the present embodiment.

As shown in FIG. 3, the carriage 25 comprises the printing unit 26, the detecting unit 27, and the nozzles 40 to eject ink. The detecting unit 27 includes a first detecting unit 27a and a second detecting unit 27b. The first detecting unit 27a and the second detecting unit 27b are arranged in the scan direction. The first detecting unit 27a and the second detecting unit 27b carry out the aforementioned detection and the like.

The nozzles 40 are arranged in the conveyance direction. A plurality of nozzle arrays 300 are arranged in the scan direction, each of which is formed by arranging the nozzles 40 in the conveyance direction. Part of the nozzle arrays 300 (i.e., some of the nozzles 40 forming each nozzle array 300), the first detecting unit 27a, and the second detecting unit 27b overlap one another as viewed in the scan direction.

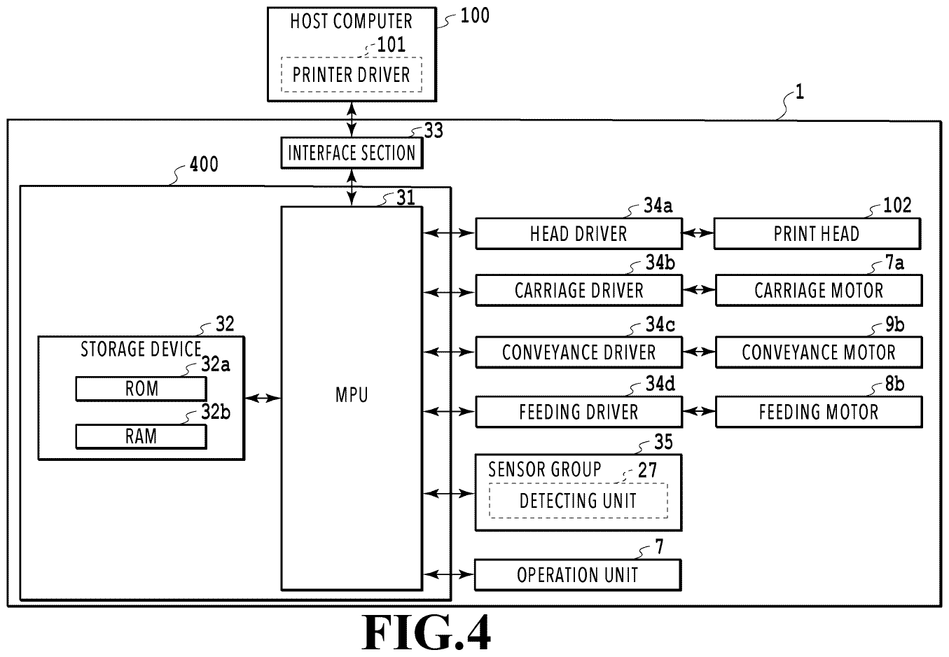

FIG. 4 is a block diagram for illustrating a control configuration of the printing apparatus 1 applicable to the present embodiment.

As shown in FIG. 4, the printing apparatus 1 comprises a control unit 400. The control unit 400 comprises an MPU 31 and a storage device 32. The printing apparatus 1 comprises an interface section 33, a head driver 34a, a carriage driver 34b, a conveyance driver 34c, a feeding driver 34d, a sensor group 35, and the operation unit 7. The sensor group 35 comprises the aforementioned detecting unit 27 and the like.

The control unit 400 controls the print head 102, a carriage motor 7a, a conveyance motor 9b, and a feeding motor 8b.

The MPU 31 is a processor to control each operation of the printing apparatus 1, data processing, and the like. The MPU 31 executes a program stored in the storage device 32 to control the entire printing apparatus 1. The storage device 32 includes, for example, a ROM 32a and a RAM 32b. The storage device 32 stores various kinds of data necessary for processing (e.g., data received from a host computer 100) as well as the program executed by the MPU 31.

The MPU 31 accepts display control of a display section of the operation unit 7 and an operator's operation of the operation unit 7. The MPU 31 controls the print head 102 via the head driver 34a. The MPU 31 controls the carriage motor 7a via the carriage driver 34b. The MPU 31 controls the conveyance motor 9b via the conveyance driver 34c. The MPU 31 controls the feeding motor 8b via the feeding driver 34d.

The MPU 31 obtains various sensing results of the sensor group 35 provided in the printing apparatus 1 and performs a control operation. For example, the MPU 31 selectively performs an ejection operation of ejecting liquid from the print head 102 by heating a heating element provided on the print head 102 and a heating operation of heating the heating element to warm liquid included in the print head 102.

The host computer 100 is, for example, a personal computer or mobile terminal (e.g., smartphone or tablet terminal) used by an operator. The host computer 100 is installed with a printer driver 101 which establishes communication between the host computer 100 and the printing apparatus 1. The host computer 100 and the MPU 31 communicate with each other via the interface section 33.

For example, in a case where execution of a print operation is input to the host computer 100 by an operator, the printer driver 101 organizes data on an image to be printed and settings for printing (information such as a quality of a printed image) and instructs the printing apparatus 1 to execute the print operation.

FIG. 5 is a schematic perspective view of an element substrate 50 applicable to the present embodiment. In the print head 102 (see FIG. 4), the element substrate 50 is a section to eject ink.

As shown in FIG. 5, the element substrate 50 is mainly formed by stacking a flow path member 54 on a substrate 51. In the substrate 51, a plurality of heaters 52 which function as energy generating elements (heating elements in the present embodiment) to generate energy for ink ejection are arranged at a predetermined pitch in the conveyance direction.

In the present embodiment, the heaters 52 are provided at a pitch of 600 dpi. Two heater arrays are provided in the scan direction, each of which is formed by arranging the heaters 52 in the conveyance direction. Between the two heater arrays, an ink supply port 56 is provided to extend in the conveyance direction and penetrate the substrate 51 in a height direction (Z direction). Ink is supplied from an ink tank (not shown) to the flow path member 54 via the ink supply port 56.

An end of an upper surface (in FIG. 5, a surface facing the direction shown by arrow Z) of the substrate 51 is provided with the temperature sensor 53 to detect the temperature of the print head 102. The temperature sensor 53 detects the temperature of ink substantially in contact with the temperature sensor 53. In the flow path member 54, the nozzles 40 are provided at positions facing the respective heaters 52. These nozzles 40 are arrayed in the conveyance direction to form the nozzle arrays 300.

The two nozzle arrays 300 are provided shifted at half the pitch in the conveyance direction. According to this configuration, dots can be printed at a printing resolution of 1200 dpi corresponding to half the pitch. The flow path member 54 is provided with a flow path 59 connected to each of the nozzles 40 and a common liquid chamber 60 connecting the ink supply port 56 to the flow paths 59.

With the above configuration, ink supplied from the ink supply port 56 to the common liquid chamber 60 is guided to the nozzles 40 through the respective flow paths 59. The ink guided to each of the nozzles 40 forms a meniscus.

In a case where a voltage is applied to the heaters 52 with a predetermined pulse in accordance with an ejection signal, film boiling occurs in ink in contact with the heaters 52 and ink is ejected from the nozzles 40 as droplets in an ejection direction (direction shown by arrow Z) by the growth energy of generated bubbles.

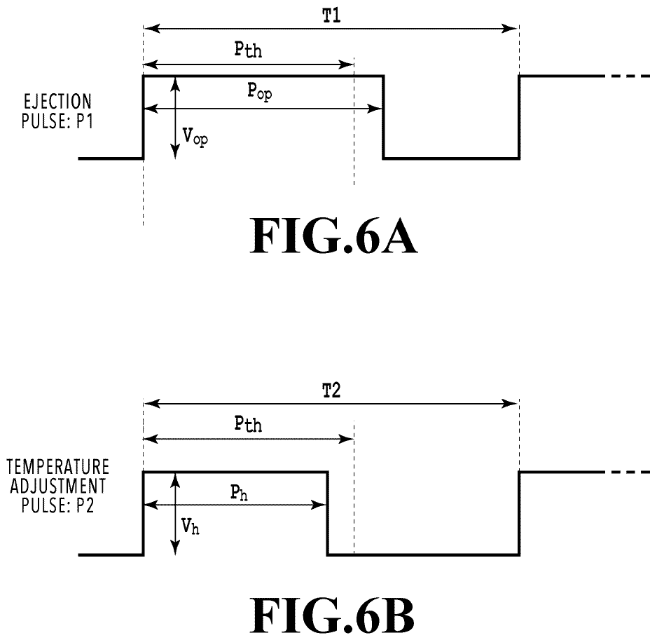

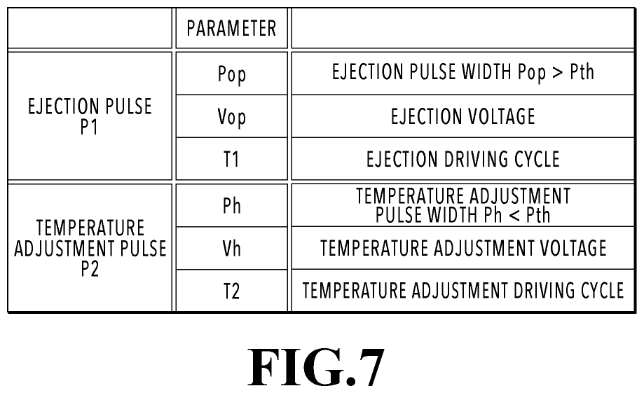

The types of pulses in the present embodiment are described below with reference to FIGS. 6A, 6B, and 7.

FIG. 6A is a diagram showing an ejection pulse P1 applicable to the present embodiment.

FIG. 6B is a diagram showing a temperature adjustment pulse P2 applicable to the present embodiment.

FIG. 7 is a diagram illustrating parameters of each of the pulses shown in FIGS. 6A and 6B.

As shown in FIG. 6A, the ejection pulse P1 for ink ejection has an ejection voltage Vop, an ejection pulse width Pop, and an ejection driving cycle T1. In a case where the ejection pulse P1 is applied to the heaters 52 (see FIG. 5), film boiling occurs in ink and the ink is ejected from the nozzles 40 (see FIG. 5 etc.).

As shown in FIG. 6B, the temperature adjustment pulse P2 used for preheating has a temperature adjustment voltage Vh, a temperature adjustment pulse width Ph, and a temperature adjustment driving cycle T2. The temperature adjustment driving cycle T2 may be different from the ejection driving cycle T1. The temperature adjustment pulse P2 is a pulse to warm ink to the extent that the ink does not reach a temperature for ink ejection. Thus, on the assumption that a lower limit value of the pulse width in the ejection pulse width Pop is Pth, the following relational expression is established.

$$Ph < Pth < Pop \qquad ( Expression 1 )$$

In the present embodiment, preheating is performed for each scan. In principle, preheating is performed by applying the temperature adjustment pulse P2 to each heater 52 (see FIG. 5) while the carriage 25 (see FIG. 2 etc.) is accelerating for performing one scan.

However, in a case where a sufficient acceleration time cannot be obtained, preheating is performed while the carriage 25 is stopped. More specifically, the temperature adjustment pulse P2 is applied to each heater 52 while the carriage 25 is stopped. In a case where the temperature detected by the temperature sensor 53 (see FIG. 5 etc.) exceeds a predetermined value, the carriage 25 starts accelerating and performs one scan. During the scan, the ejection pulse P1 is applied to each heater 52 in accordance with an ejection signal.

The printing unit 26 ejects ink according to print data while the carriage 25 is moving in the scan direction, whereby an image corresponds to one scan is printed on the print medium PM. In a case where the printing unit 26 performs one scan, the print medium PM is conveyed in the conveyance direction a distance corresponding to one scan. Such a scan by the printing unit 26 and a conveying operation of the print medium PM are alternately repeated to gradually print an image on the print medium PM.

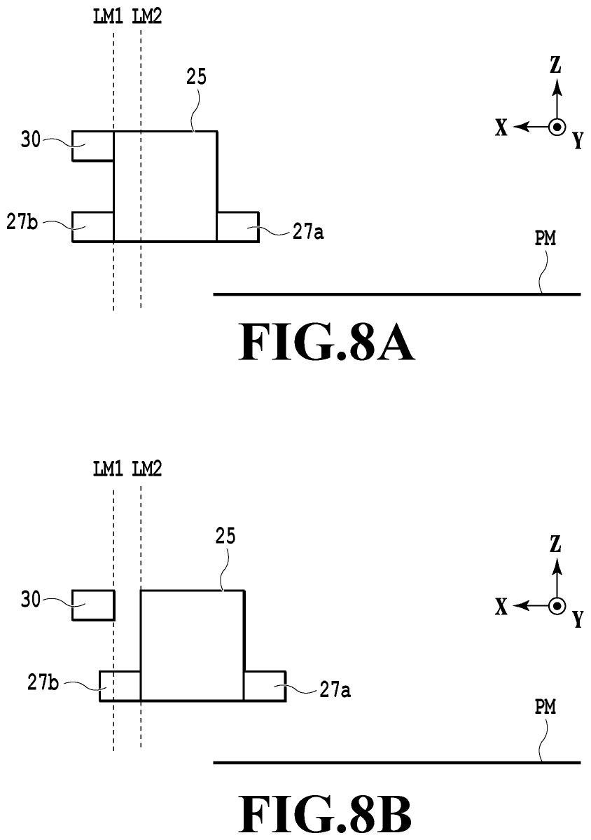

FIGS. 8A and 8B are diagrams showing an example of a reversing position of the carriage 25 applicable to the present embodiment. FIGS. 8A and 8B show the left end side of the printing apparatus 1 (see FIG. 1 etc.) viewed from the front, but the right end side of the printing apparatus 1 viewed from the front is also configured in the same manner.

In the present embodiment, a position at which the carriage 25 is switched from a forward scan to a backward scan is shown as an example of the reversing position. However, the reversing position is not limited to this example. Anther example of the reversing position is a position at which the carriage 25 is switched from a backward scan to a forward scan.

As shown in FIG. 8A, the printing apparatus 1 comprises a contacting member 30 touchable by the carriage 25. For example, a reference position of the carriage 25 can be set by bringing the carriage 25 in contact with the contacting member 30. Incidentally, a position of a portion of the carriage 25 in contact with the contacting member 30 is shifted from the position of the nozzles 40 (see FIG. 5 etc.) in the conveyance direction.

In a case where an abnormal reciprocal movement of the carriage 25 occurs for any reason, the carriage 25 may stop moving by contacting the contacting member 30. Thus, the contacting member 30 also functions as a stopper in addition to setting the reference position. In a case where a scan is normally performed, the carriage 25 is reversed at a position not in contact with the contacting member 30.

For example, in micro margin printing (printing with only a margin of 1.0 mm or less extending inward from the end of the print medium PM) or the like, the end of the print medium is detected in each print scan and a print area of each scan is adjusted based on the detected end position. In micro margin printing, in a case where the print medium PM is skewed while being conveyed, the end of the print medium PM (left end in the example of FIG. 8A) may be shifted in a forward scan direction (left in FIGS. 8A and 8B). In this case, the printing position of the image is corrected to the left and accordingly a scan area of the carriage 25 is also corrected to the left.

In general printing, since an image is printed with a margin of about 5.0 mm extending inward from the end of the print medium PM (left end in the example of FIGS. 8A and 8B), the carriage 25 is less likely to contact the contacting member 30.

However, in a case where the print medium PM is skewed while micro margin printing is performed by a relatively-small printing apparatus 1, it is considered that the scan area of the carriage 25 becomes close to the contacting member 30. In a case where the scan area of the carriage 25 thus becomes close to the contacting member 30, the carriage 25 may contact the contacting member 30 as shown in FIG. 8A. Accordingly, in the present embodiment, the position of the carriage is managed such that the carriage can be stopped at an appropriate position even in a case where the print medium PM is skewed.

FIG. 8B is a diagram showing an example of the reversing position of the carriage 25 applicable to the present embodiment.

As shown in FIG. 8B, a second limit position LM2 of the scan area of the carriage 25 is provided inside a first limit position LM1 at which the contacting member 30 contacts the carriage 25. The second limit position LM2 is managed as absolute coordinates away from the reference position of the carriage 25 in the scan direction. The second limit position LM2 has a value specific to the printing apparatus 1 irrespective of the position of the end of the print medium PM.

In the present embodiment, a distance between the first limit position LM1 and the second limit position LM2 is about 1.0 mm. However, the distance between the first limit position LM1 and the second limit position LM2 is not limited to 1.0 mm. In a case where a standard-size print medium PM is conveyed with no skew, a distance between the second limit position LM2 and the end of the print medium PM (left end in the example of FIG. 8B) in the scan direction is about 78.4 mm. In a case where there is no skew and the carriage 25 is located at the second limit position LM2, a distance between the end of the print medium PM (left end in the example of FIG. 8B) and the nozzle 40 closest to the end is about 17.0 mm.

The ROM 32a of the present embodiment stores the coordinates of the second limit position LM2. During a print operation, the movement of the carriage 25 is restricted (more specifically, stopped) such that the carriage 25 does not move beyond the second limit position LM2. According to this configuration, even in a case where the print medium PM is skewed, a contact between the carriage 25 and the contacting member 30 can be prevented during a scan. Further, in line with the above movement control of the carriage 25, execution of preheating in each scan is appropriately controlled.

In the present embodiment, it is assumed that the second limit position LM2 is provided to prevent a contact between the carriage 25 and the contacting member 30. However, a different limit position than the second limit position LM2 may be provided to prevent a contact between the carriage 25 and a different member.

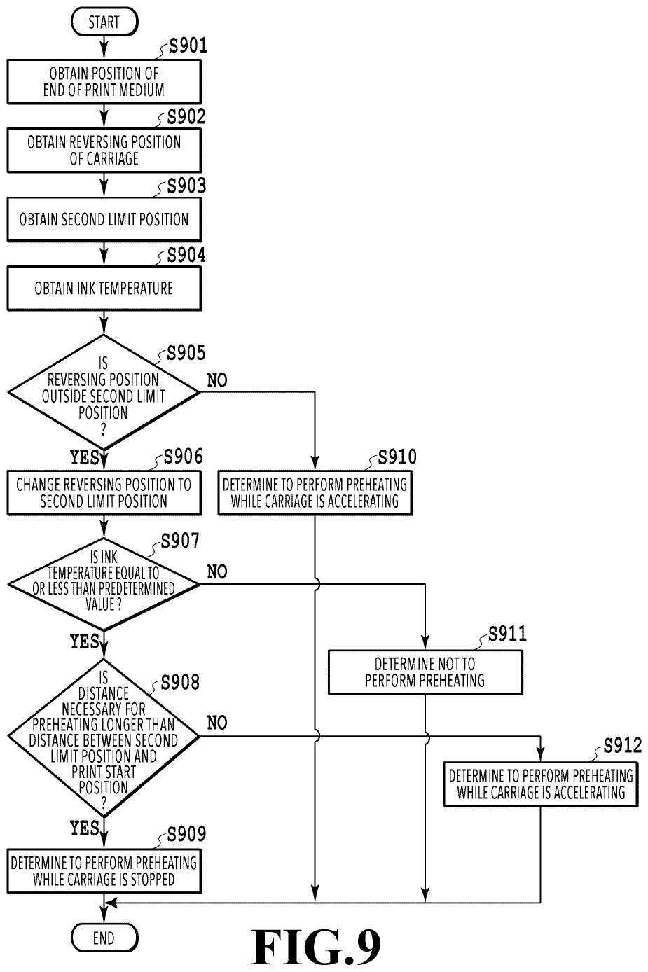

FIG. 9 is a flowchart showing a method of determining preheating and the reversing position of the carriage 25 (see FIG. 2 etc.) in each print scan in the present embodiment. Sign “S” in FIG. 9 means a step. The procedure shown in this flowchart is performed by the MPU 31 loading a program code stored in the ROM 32a into the RAM 32b (see FIG. 4) and executing the program code. This flowchart is started at a timing of detection of the end of the print medium PM (see FIG. 2 etc.) by the detecting unit 27 in each print scan.

In S901, the MPU 31 obtains the position of the end of the print medium PM in the width direction (X direction) sensed by the detecting unit 27 (see FIG. 3 etc.).

In S902, the MPU 31 obtains the reversing position of the carriage 25 at which the current scan is switched to the next scan. The reversing position of the carriage 25 is derived from the position of the end of the print medium PM in the width direction sensed by the detecting unit 27. The reversing position should be such a position that the nozzle array 300 at the most upstream side of the print head in the scan direction is a predetermined distance away from the end of the image in the scan direction, and the predetermined distance differs according to a print condition (print mode). Thus, the MPU 31 derives the reversing position from the position of the end sensed in S901 and the print condition (print mode).

However, if the end position sensed in immediately preceding S901 cannot be immediately used for a reason such as a processing speed, information on the end position sensed in a previous scan may be used. In this case, an average value may be derived from end positions sensed in a plurality of previous scans. This can prevent an abrupt change of control and reduce a disruption at the end of the image.

In S903, the MPU 31 obtains the position of the second limit position LM2 (see FIGS. 8A and 8B). More specifically, the MPU 31 refers to the ROM 32a and obtains the coordinates of the second limit position LM2 corresponding to the print condition (print mode).

In S904, the MPU 31 obtains the temperature of ink. More specifically, the MPU 31 obtains a detection value of the temperature sensor 53 (FIG. 5) at this point in time.

In S905, the MPU 31 determines whether the reversing position of the carriage 25 derived in S902 is outside the second limit position LM2. If the reversing position of the carriage 25 is outside the second limit position LM2 (YES in S905), the MPU 31 executes the process of S906. If the reversing position of the carriage 25 is inside the second limit position LM2 (NO in S905), the MPU 31 executes the process of S910.

In S906, the MPU 31 changes the reversing position of the carriage 25 from the position obtained in S902 to the second limit position LM2.

In S907, the MPU 31 determines whether the temperature of ink obtained in S904 is equal to or less than a predetermined value. If the temperature of ink is equal to or less than the predetermined value (YES in S907), the MPU 31 executes the process of S908. If the temperature of ink exceeds the predetermined value (NO in S907), the MPU 31 executes the process of S911.

In S908, the MPU 31 determines whether a distance necessary for preheating is longer than a distance between the second limit position LM2 and a print start position. If the distance necessary for preheating is longer than the distance between the second limit position LM2 and the print start position (YES in S908), the MPU 31 executes the process of S909. If the distance necessary for preheating is equal to or less than the distance between the second limit position LM2 and the print start position (NO in S908), the MPU 31 executes the process of S912.

In S909, the MPU 31 determines to perform preheating while the carriage 25 is stopped.

If determines in S905 that the reversing position of the carriage 25 is inside the second limit position LM2, the MPU 31 determines in S910 to perform preheating while the carriage 25 is accelerating.

If determines in S907 that the temperature of ink is equal to or less than the predetermined value, the MPU 31 determines in S911 not to perform preheating.

If determines in S908 that the distance necessary for preheating is equal to or less than the distance between the second limit position LM2 and the print start position, the MPU 31 determines in S912 to perform preheating while the carriage 25 is accelerating.

For example, if this process is ended with the process of S909, the carriage 25 is stopped at the second limit position according to the setting in S906 and preheating is performed while the carriage 25 is stopped according to the setting in S909. After that, the carriage 25 changes the scan direction and starts a scan.

If this process is ended with the process of S910, the carriage 25 is reversed at the reversing position obtained in S902 and starts the next scan, and preheating is performed while the carriage 25 is accelerating.

If this process is ended with the process of S911, the carriage 25 is reversed at the second limit position according to the setting in S906 and starts the next scan without execution of preheating.

If this process is ended with the process of S912, the carriage 25 is reversed at the second limit position according to the setting in S906 and starts the next scan, and preheating is performed while the carriage 25 is accelerating.

This is the end of the processing flow of determining the reversing position of the carriage 25 and determining whether to execute preheating.

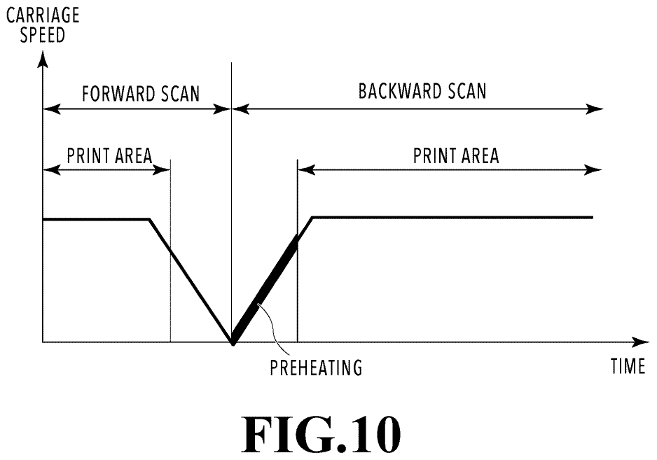

FIG. 10 is a diagram showing a preheating timing applicable to the present embodiment. FIG. 10 is based on the assumption that the process of S912 (see FIG. 9) is performed.

As shown in FIG. 10, in a forward scan, the carriage 25 (see FIG. 2 etc.) decelerates as getting closer to the rear end of the print area. At the timing of switching from the forward scan to a backward scan (i.e., at the reversing position), the carriage 25 is temporarily stopped. After that, in the backward scan, the carriage 25 accelerates, enters the print area, and then continues the backward scan at a constant speed.

In the present embodiment, preheating is performed between the start of the backward scan and the arrival of the carriage 25 at the print area of the backward scan. That is, preheating is performed while the carriage 25 is accelerating. The above step is also performed in switching from the backward scan to the forward scan.

As described above, according to the printing apparatus 1 (see FIG. 1 etc.) of the present embodiment, in a case where preheating is necessary and an acceleration distance necessary for preheating is secured at the start of a print scan, preheating is performed while the carriage 25 is accelerating. On the other hand, in a case where preheating is necessary but an acceleration distance necessary for preheating is not secured, preheating is performed while the carriage is stopped. For example, between the end of the forward scan and the start of the backward scan, preheating is performed with the carriage 25 stopped.

According to the above configuration, in case of necessity of preheating, preheating is performed while the carriage is accelerating in principle. On the other hand, preheating is performed with the carriage stopped only in a case where an acceleration distance necessary for preheating is not secured. As a result, a time to stop the carriage for preheating can be minimized and a decrease in throughput in the entire print operation can be reduced.

Therefore, according to the printing apparatus 1 of the present embodiment, preheating can be efficiently performed.

Further, in the printing apparatus 1 of the present embodiment, in a case where the reversing position of the carriage is outside the second limit position, the reversing position of the carriage in the next scan is changed to the second limit position. According to this configuration, even on the occurrence of some kind of abnormality (e.g., a skew of the print medium PM) during a scan, the reversing position of the carriage is changed in the next scan such that a clearance between the carriage and the contacting member is secured.

Therefore, the possibility of a contact between the carriage and the contacting member can be reduced.

### Second Embodiment

The second embodiment in the technique of the present disclosure is described below with reference to the drawings. The present embodiment is to provide a printing apparatus 1 (see FIG. 1 etc.) which can perform preheating more efficiently. In the following description, features similar or corresponding to those of the first embodiment are denoted by the same reference numerals to omit their description and differences are mainly described.

In the first embodiment, preheating is performed while the carriage is accelerating. However, the timing in which preheating can be performed is not limited to while the carriage is accelerating. Preheating may be performed while the carriage is decelerating.

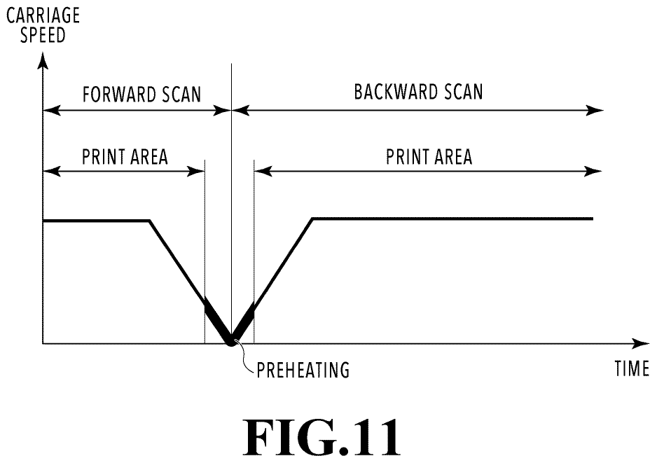

FIG. 11 is a diagram showing the preheating timing applicable to the present embodiment.

As shown in FIG. 11, in the present embodiment, preheating is performed between the end of printing in the forward scan and the start of printing in the backward scan. That is, preheating is performed while the carriage is decelerating in the forward scan and while the carriage is accelerating in the backward scan. According to this configuration, since preheating is started while the carriage is decelerating in the forward scan, a distance necessary for preheating of the carriage while the carriage is accelerating in the backward scan can be reduced as compared to the first embodiment. The above step is also performed in switching from the backward scan to the forward scan.

Accordingly, the frequency of stopping the carriage for preheating can be reduced as compared to the first embodiment and throughput can be further increased. Further, a carriage scan region between the reversing position of the carriage 25 and the end of the image can be reduced as compared to the first embodiment and the apparatus can be further downsized.

The flowchart of FIG. 9 is also applicable to the present embodiment. In this case, for example, in S909, the MPU 31 may determine to perform preheating while the carriage is decelerating and accelerating as shown in FIG. 11, instead of stopping the carriage. Further, in S910 and S912, the MPU 31 may determine to perform preheating while the carriage is accelerating as shown in FIG. 10.

Therefore, according to the printing apparatus 1 of the present embodiment, preheating can be performed more efficiently. Further, upsizing of the printing apparatus 1 can be prevented.

### Third Embodiment

The third embodiment in the technique of the present disclosure is described below with reference to the drawings. The present embodiment is to provide a printing apparatus 1 (see FIG. 1 etc.) which can perform preheating even in a case where a distance at which preheating can be performed is relatively small. In the following description, features similar or corresponding to those of the first and second embodiments are denoted by the same reference numerals to omit their description and differences are mainly described.

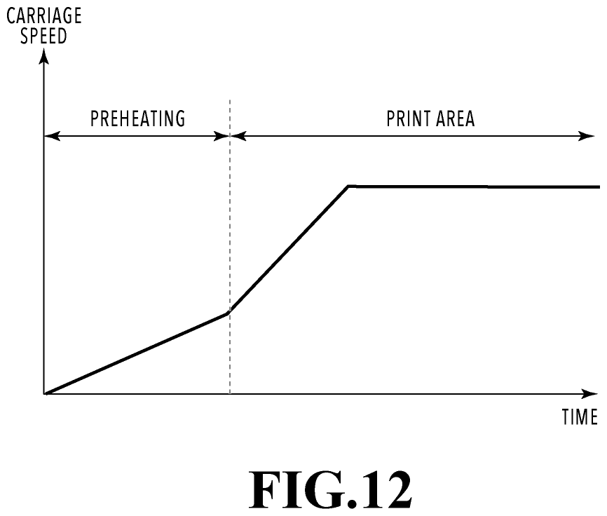

FIG. 12 is a diagram showing a change in acceleration of the carriage 25 applicable to the present embodiment.

As shown in FIG. 12, in the present embodiment, it is assumed that not only preheating but also a print operation is performed while the carriage 25 (see FIG. 2 etc.) is accelerating. However, an acceleration during execution of preheating is different from an acceleration during execution of a print operation. More specifically, the acceleration (slope of the carriage speed) during execution of preheating is less than the acceleration (slope of the carriage speed) during execution of a print operation.

This is to reduce a distance of movement of the carriage 25 during preheating. According to this configuration, in a relatively-small printing apparatus, even in a case where there is a short distance between the end of the print medium PM (see FIG. 2 etc.) and the limit position of movement of the carriage 25, the carriage 25 moves the distance at a relatively-low speed. Accordingly, a time necessary for preheating can be secured. For example, even in a case where a margin of the print medium PM in the width direction is relatively small, preheating can be performed by relatively reducing the acceleration of the carriage 25.

The flowchart of FIG. 9 is also applicable to the present embodiment. In this case, for example, if it is determined in S910 or S912 to perform preheating while the carriage is accelerating, the carriage accelerates as shown in FIG. 12.

Incidentally, although the acceleration during preheating is constant in the present embodiment, the acceleration may be changed during preheating as long as a time necessary for preheating can be secured and the size of the printing apparatus 1 is not affected. The same applies to the first embodiment.

As described above, according to the printing apparatus 1 of the present embodiment, preheating can be performed even in a case where a distance at which preheating can be performed is relatively small. Further, according to the configuration of the present embodiment, throughput is not reduced as compared to the case of performing preheating with the carriage 25 stopped.

### Other Embodiments

The order of the processes shown in FIG. 9 may be arbitrarily changed and the processes may be performed simultaneously with each other.

Further, in the first embodiment, in a case where the reversing position of the carriage 25 is outside the second limit position, the reversing position of the carriage 25 is always changed to the second limit position. However, the reversing position of the carriage 25 may be changed to a position other than the second limit position as long as the carriage 25 can be prevented from contacting the contacting member and preheating can be finished before the start of printing.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-164344, filed Sep. 20, 2024, which is hereby incorporated by reference herein in its entirety.

According to the printing apparatus of the present disclosure, preheating can be efficiently performed.

What is claimed is:

1. A printing apparatus comprising:
a print head configured to print an image on a print medium by ejecting liquid;
a carriage mounted with the print head and configured to perform a reciprocal scan in a scan direction;
a heating section configured to selectively perform an ejection operation of ejecting liquid from the print head by heating a heating element provided on the print head and a heating operation of heating the heating element to warm liquid included in the print head; and
a control section configured to control movement of the carriage and the heating section,
wherein in a case where a distance between a reversing position at which the scan direction of the carriage is switched and a position at which the print head starts ejection in a next scan is longer than a predetermined distance, the control section causes the heating section to execute the heating operation while the carriage is accelerating in the next scan.

2. The printing apparatus according to claim 1, wherein
in a case where the distance between the reversing position at which the scan direction of the carriage is switched and the position at which the print head starts ejection in the next scan is equal to or less than the predetermined distance, the control section causes the heating section to execute the heating operation while the carriage is stopped before the next scan.

3. The printing apparatus according to claim 1, further comprising a temperature sensor configured to sense a temperature of liquid included in the print head,
wherein in a case where the temperature sensed by the temperature sensor is higher than a predetermined temperature, the control section does not cause the heating section to execute the heating operation in the next scan.

4. The printing apparatus according to claim 1, further comprising a sensing section configured to move together with the carriage and sense an end of the print medium in the scan direction,
wherein the control section derives the reversing position from a position of the end of the print medium sensed by the sensing section.

5. The printing apparatus according to claim 1, wherein
in a case where the reversing position is located outside a predetermined limit position of movement of the carriage in the scan direction, the control section changes the reversing position to the limit position.

6. The printing apparatus according to claim 1, wherein
the control section causes the heating section to execute the heating operation while the carriage is decelerating in a current scan and while the carriage is accelerating in the next scan.

7. The printing apparatus according to claim 1, wherein
while the carriage is accelerating in the next scan, the control section causes the heating section to start the ejection operation after executing the heating operation.

8. The printing apparatus according to claim 7, wherein
an acceleration of the carriage during execution of the heating operation is different from an acceleration of the carriage during execution of the ejection operation.

9. The printing apparatus according to claim 8, wherein
the acceleration of the carriage during execution of the heating operation is less than the acceleration of the carriage during execution of the ejection operation.

10. A control method of a printing apparatus, the printing apparatus comprising:
a print head configured to print an image on a print medium by ejecting liquid;
a carriage mounted with the print head and configured to perform a reciprocal scan in a scan direction; and
a heating section configured to selectively perform an ejection operation of ejecting liquid from the print head by heating a heating element provided on the print head and a heating operation of heating the heating element to warm liquid included in the print head,
the control method comprising:
in a case where a distance between a reversing position at which the scan direction of the carriage is switched and a position at which the print head starts ejection in a next scan is longer than a predetermined distance, executing the heating operation while the carriage is accelerating in the next scan, and
executing the ejection operation after the carriage is scanned to the predetermined distance.

11. The control method according to claim 10, wherein
in a case where the distance between the reversing position at which the scan direction of the carriage is switched and the position at which the print head starts ejection in the next scan is equal to or less than the predetermined distance, the heating operation is executed while the carriage is stopped before the next scan.

12. The control method according to claim 10, wherein
the printing apparatus further comprises a temperature sensor configured to sense a temperature of liquid included in the print head, and
in a case where the temperature sensed by the temperature sensor is higher than a predetermined temperature, the heating operation is not executed in the next scan.

13. The control method according to claim 10, wherein
the printing apparatus further comprises a sensing section configured to move together with the carriage and sense an end of the print medium in the scan direction, and
the reversing position is derived from a position of the end of the print medium sensed by the sensing section.

14. The control method according to claim 10, wherein
in a case where the reversing position is located outside a predetermined limit position of movement of the carriage in the scan direction, the reversing position is changed to the limit position.

15. The control method according to claim 10, wherein
the heating operation is executed while the carriage is decelerating in a current scan and while the carriage is accelerating in the next scan.

16. The control method according to claim 10, wherein
while the carriage is accelerating in the next scan, the ejection operation is started after the heating operation is executed.

17. The control method according to claim 16, wherein
an acceleration of the carriage during execution of the heating operation is different from an acceleration of the carriage during execution of the ejection operation.

18. The control method according to claim 17, wherein
the acceleration of the carriage during execution of the heating operation is less than the acceleration of the carriage during execution of the ejection operation.

19. A non-transitory computer readable storage medium storing a program which causes a computer to execute a method of controlling an image processing apparatus, the method comprising:
in a case where a distance between a reversing position at which a scan direction of a carriage is switched, the carriage being mounted with a print head and configured to perform a reciprocal scan in the scan direction, the print head being configured to print an image on a print medium by heating a heating element and ejecting liquid, and a position at which the print head starts ejecting liquid in a next scan is longer than a predetermined distance, heating the heating element to warm liquid included in the print head while the carriage is accelerating in the next scan, and
executing the ejection operation after the carriage is scanned to the predetermined distance.
